(19) United States
(12) Patent Application Publication
(10) Pub. No.: US 2020/0079178 A1
(43) Pub. Date: Mar. 12, 2020

(54) SENSOR UNIT OF A VEHICLE

(71) Applicant: Robert Bosch GmbH, Stuttgart (DE)

(72) Inventors: Debora Maria Mitter Marques, Tamm (DE); Ingmar Schultz, Korntal-Muenchingen (DE); Markus Kienzle, Lehrensteinsfeld (DE); Mirko Hattass, Stuttgart (DE); Thomas Maurer, Stuttgart (DE)

(21) Appl. No.: 16/552,785

(22) Filed: Aug. 27, 2019

(30) Foreign Application Priority Data
Sep. 6, 2018 (DE) 102018215142.3

(51) Int. Cl. B60H 1/00; F28F 9/02; G01S 17/88

(52) U.S. Cl. CPC B60H 1/00771; F28F 9/0209; G01S 7/4817; G01S 17/88; F28F 2009/0292; B60H 1/00271

(57) ABSTRACT

A sensor unit including a housing having cooling fins, and a cooling attachment which is mounted on the cooling fins and has a fluid inlet and a fluid outlet, so that a fluid is able to flow along the cooling fins, the placement of the cooling fins and the cooling attachment between the fluid inlet and the fluid outlet allowing a predefined temperature gradient to be adjusted on the housing.

### RELATED APPLICATION INFORMATION

The present application claims priority to and the benefit of German patent application no. 10 2018 215 142.3, which was filed in Germany on Sep. 6, 2018, the disclosure of which is incorporated herein by reference.

### FIELD OF THE INVENTION

The present invention relates to a sensor unit of a vehicle. In particular, the sensor unit features improved cooling compared to the prior art. In addition, the invention relates to a system, including such a sensor unit as well as a temperature-adjusting unit.

### BACKGROUND INFORMATION

It is believed to be understood from the back that devices with high electric power consumption typically require special measures to prevent components of the device from overheating. If these measures within the device are not sufficient, the corresponding heat output must be removed externally in purposeful fashion. To that end, often cooling structures are provided on the device which, on one hand, enlarge the surface, and on the other hand, increase the effectiveness for free convection. In addition, a fan may blow on these cooling structures to thus achieve good heat dissipation. An external fan is necessary for this purpose, which must be mounted in accordance with an applicable specification for the relative positioning of fans and cooling structures. In addition, ambient conditions that are able to limit efficiency in terms of flow dynamics may have to be considered.

### SUMMARY OF THE INVENTION

The sensor unit according to the present invention facilitates efficient heat dissipation, in particular, a possibility being afforded for a simple connection of an external cooling system and/or heating system. Namely, a predefined temperature gradient may thus be set. Notably, the temperature gradient may also be zero.

The sensor unit according to the present invention includes a housing having cooling fins. In addition, the sensor unit includes a cooling attachment. The cooling attachment is mounted on the cooling fins. Furthermore, the cooling attachment has a fluid inlet and a fluid outlet, so that a fluid is able to flow along the cooling fins from the fluid inlet to the fluid outlet. By placing cooling fins and a cooling attachment between the fluid inlet and the fluid outlet, a predefined temperature gradient is set on the housing. As described above, said temperature gradient may also amount to zero. If a cooling fluid is supplied via the fluid inlet, this cooling fluid then warms up on the way to the fluid outlet. Consequently, a temperature gradient results on the cooling fins and thus on the housing. However, by suitable cross-sectional changes and/or fluid guides, it is possible for such a gradient not to occur, as the heating of the fluid is equalized. For example, this is achievable by an increasing enlargement of a fluid channel between the fluid inlet and fluid outlet.

The fluid inlet and fluid outlet are connectable advantageously to an external cooling system. Thus, the layout of the external cooling system is separate from the layout of the sensor unit. In particular, an installation space required for the sensor unit is therefore minimized, while at the same time, flexible integration into a cooling system is achieved. Advantageously, either the fluid outlet may be connected to the external cooling system, or alternatively, the heated fluid may also simply be allowed to discharge into a surrounding area. In any case, owing to the interplay of the cooling fins and cooling attachment, optimal flow around the cooling fins, and with that, optimal cooling of the sensor unit are realized.

The further embodiments include further developments of the present invention.

The cooling fins may be disposed in meander-shaped fashion, the fluid inlet and the fluid outlet being placed at respective ends of the meander shape. In addition, the cooling attachment may cover the cooling fins. Thus, a meander-shaped duct is generated, which extends between the fluid inlet and fluid outlet. Efficient cooling of the sensor unit is thereby achieved, since the cooling fins come completely in contact with a fluid flowing between the fluid inlet and outlet. In particular, a cross-section of the meander-shaped channel is variable, to thus set a desired temperature gradient.

In an alternative specific embodiment, the cooling fins are disposed in a star shape. The fluid inlet is placed at a center point of the star shape. Thus, fluid flows advantageously from the fluid inlet in star-shaped fashion along the cooling fins to the outside. The fluid outlet therefore represents an outer area of the star shape. In this case, it is advantageous if the fluid outlet is used merely to release the fluid to a surrounding area. At the same time, owing to the star shape, the cooling fins are all cooled virtually identically. Namely, a state may thus be reached in which no temperature gradient, that is, a temperature gradient of zero, is present on the housing.

The cooling fins may be disposed on an outer side of the housing. The cooling attachment is therefore merely slipped onto the outer side of the housing, to thus interact with the cooling fins. This interaction ensures optimal cooling of the sensor unit. At the same time, painstaking adjustments are avoided, since due to the provision of the cooling element, a fan does not have to be oriented exactly to the cooling fins. Rather, a suitable cooling unit, in the simplest case, a fan or, alternatively, also an air conditioner may be connected via a hose system or tube system to the cooling attachment, in order to cool the sensor unit.

The housing advantageously encloses a sensor, at least in some areas. Particularly advantageously, the sensor is a lidar sensor. If the previously described sensor unit is a lidar sensor unit or any other optical sensor unit, then the housing may have a glass cover. Lidar sensor units usually generate waste heat, which must be removed by cooling. The previously described cooling attachment is therefore optimally suited for use with lidar sensor units.

Advantageously, the housing and the cooling attachment are joined permanently and/or in fluid-tight fashion. Permanent joining prevents unintended loosening of the cooling attachment from the housing, so that cooling is always ensured and a loss of cooling is avoided. The fluid-tight connection allows efficient cooling, since the entire fluid flow, which is fed to the fluid inlet, must flow along the cooling fins of the housing up to the fluid outlet. Thus, the sensor unit is able to be cooled safely and reliably.

In particular, the fluid is an air- and/or water- and/or cooling medium. Different fluids may be utilized, depending on the use required. The fluid is advantageously air, since it is easily and inexpensively manageable, especially also in vehicles.

The cooling attachment extends advantageously along an extension direction of the cooling fins. As a result, a projection height beyond the cooling fins is present, said projection height corresponding to a maximum of 50%, especially a maximum of 30% of a height of the cooling fins. This means, specifically, that the cooling fins are applied with a predefined height on the surface of the housing of the sensor unit. The cooling attachment then projects with the above-described projection height, beyond the edge areas of the cooling fins. Thus, the sensor unit has a very small volume, this volume being increased only minimally by the placement of the cooling attachment. At the same time, there is no need to mount external fans or the like. Rather, an external cooling device may be connected to the cooling attachment via a hose system and/or tube system or something similar. The external cooling device may be situated at a location different from the position of the sensor unit. The size of the external cooling unit is therefore not relevant for the installation space of the sensor unit.

In addition, the present invention relates to a system, including a sensor unit as described above. The system also includes a temperature-adjusting unit. The temperature-adjusting unit is advantageously a cooling element. However, the temperature-adjusting unit may also be a heater. Alternatively, a combination of cooling element and heating device is possible, as well. The fluid inlet of the sensor unit is coupled to the temperature-adjusting unit. Thus, the temperature-adjusting unit is able to transmit heated and/or cooled fluid to the fluid inlet. The temperature-adjusting unit is connected advantageously via a control line to the sensor unit. An exchange of data between the sensor unit and the temperature-adjusting unit is therefore enabled. This makes it possible either to feed a fluid to the fluid inlet or to stop a fluid feed to the fluid inlet, depending on the requirements of the sensor unit. A temperature of the sensor unit may therefore be maintained at an optimal operating temperature. Overheating and undercooling are thus prevented, while at the same time, a very compact design is provided.

As described above, the temperature-adjusting unit may be configured to supply cooled and/or heated fluid to the fluid inlet. In particular, this is selected on the basis of a temperature specified by the sensor unit through the control line. Thus, optimal temperature control may be achieved for the sensor unit.

In the following, exemplary embodiments of the present invention are described in detail with reference to the accompanying drawing.

### BRIEF DESCRIPTION OF THE DRAWING

FIG. 1 shows a first schematic view of a sensor unit according to one exemplary embodiment of the invention.

FIG. 2 shows a second schematic view of the sensor unit according to the exemplary embodiment of the invention.

FIG. 3 shows a schematic view of a first alternative of the sensor unit according to the exemplary embodiment of the invention.

FIG. 4 shows a schematic view of a second alternative of the sensor unit according to the exemplary embodiment of the invention.

FIG. 5 shows a schematic view of a system according to one exemplary embodiment of the invention.

### DETAILED DESCRIPTION

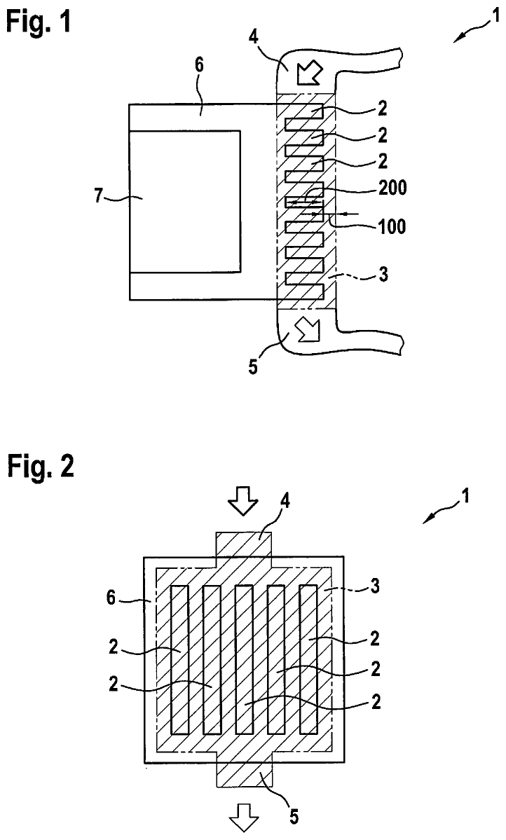

FIG. 1 shows schematically a sensor unit 1 of a vehicle. Sensor unit 1 includes a plurality of cooling fins 2. Cooling fins 2 are also shown in FIG. 2. Thus, FIG. 2 shows the same sensor unit 1 from a different perspective. Cooling fins 2 are applied to a housing 6 of sensor unit 1. Housing 6 encompasses a sensor 7, particularly an optical sensor, and especially a lidar sensor.

A cooling attachment 3 is mounted on cooling fins 2, an interplay of cooling fins 2 and cooling attachment 3 determining a fluid path within the cooling attachment. Cooling attachment 3 has a fluid inlet 4 and a fluid outlet 5. Namely, a fluid is able to be fed to cooling attachment 3 via fluid inlet 4, while said fluid is able to be removed from sensor unit 1 via fluid outlet 5. In particular, a predefined temperature gradient may be adjusted on housing 6 by way of cooling fins 2. Various forms of cooling fins 2 may be used for that purpose, which is described below with reference to FIGS. 2 through 4.

Starting from housing 6, cooling fins 2 extend along an extension direction. Cooling fins 2 have a cooling-fin height 200. Specifically, cooling-fin height 200 is measured parallel to the aforementioned extension direction. In addition, the cooling attachment extends along the same extension direction as cooling fins 2, projecting by a projection height 100 beyond cooling fins 2. In particular, this means that an installation space including projection height 100 increases the installation space for housing 6. Specifically, the projection height amounts to a maximum of 50%, especially a maximum of 30%, of cooling-fin height 200. Thus, cooling attachment 3 increases the installation space of housing 6 only minimally, while at the same time, additional cooling devices such as a fan, for instance, do not have to be placed directly on sensor unit 1.

FIGS. 2 through 4 show various alternatives of the form of cooling fins 2. In FIG. 2, all these cooling fins 2 are disposed parallel to each other. If a fluid flows into fluid inlet 4, this fluid is then guided along parallel-running cooling fins 2 to fluid outlet 5.

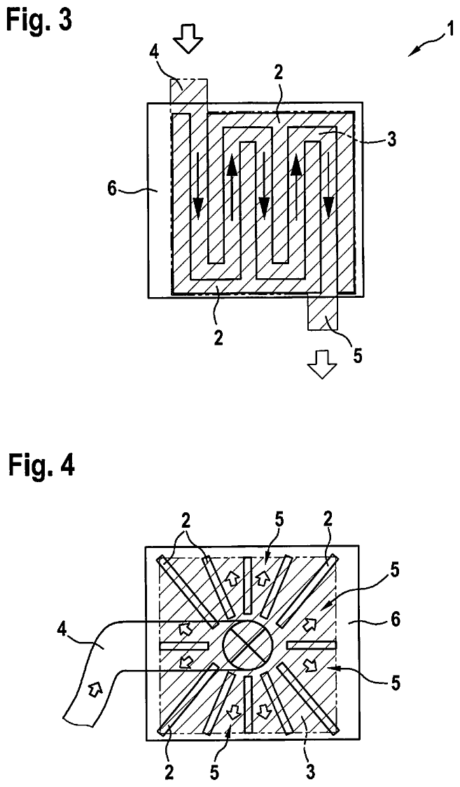

FIG. 3 shows a design of cooling fins 2, such that a meander-shaped channel is formed which extends between fluid inlet 4 and fluid outlet 5. A fluid fed to fluid inlet 4 must therefore run along this meander shape in order to get to fluid outlet 5. Compared to the alternative from FIG. 2, a path which the fluid must cover within cooling attachment 3 is thereby increased. As a result, cooling capacity is able to be improved.

Finally, FIG. 4 shows a further alternative. In this case, cooling fins 2 are disposed in a star shape. Fluid inlet 4 is placed in the center of the star shape. Owing to the star shape, a temperature gradient on housing 6 is reduced. Rather, the cooling through the star-shaped cooling fins takes place equally or nearly equally at every position. In this case, fluid outlet 5 represents the outer periphery of star-shaped-configured cooling fins 2. Thus, in the alternative shown in FIG. 4, the cooling medium is introduced centrally in the middle of cooling fins 2, while the heated fluid is discharged at peripherally-situated fluid outlets 5 into the surrounding area.

Owing to the star shape as shown in FIG. 4, a predefined temperature gradient on housing 6 is advantageously zero or virtually zero. That means that entire housing 6 may be cooled at the same rate.

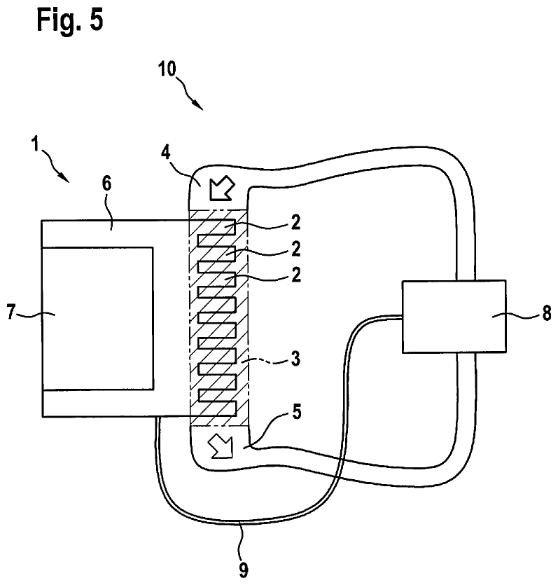

Finally, FIG. 5 shows a system made up of sensor unit 1 as described above, and temperature-adjusting unit 8. Temperature-adjusting unit 8 is connected via a control line 9 to sensor unit 1. In particular, temperature-adjusting unit 8 is a cooling element and/or a heating element.

It is further provided that temperature-adjusting unit 8 is coupled at least to fluid inlet 4. FIG. 5 shows how temperature-adjusting unit 8 is coupled additionally to fluid outlet 5, to thus achieve a circulating operation of the cooling fluid.

With the aid of control line 9, it is possible for sensor unit 1 to easily and inexpensively control its own temperature. Specifically, by stopping the fluid feed at fluid inlet 4 and/or by varying the rate of flow of fluid through cooling attachment 3, it is possible to influence the temperature adjustment on housing 6 and therefore to influence sensor unit 1 itself. In particular, with the aid of control line 9, it may also be determined whether temperature-adjusting unit 8 should supply heated or cooled fluid via fluid inlet 4. In any case, optimal heating and/or heat dissipation of sensor unit 1 is thus achievable, in particular, a temperature of sensor unit 1 being able to remain within a predetermined tolerance window. This tolerance window is reduced considerably compared to the related art, while at the same time, a minimal installation space may be provided for the sensor unit. This is especially advantageous if sensor unit 1 is installed in a vehicle in order to detect an area surrounding the vehicle.

Particularly advantageously, sensor unit 1 is a lidar system. In particular, the lidar system is mounted in a vehicle. Thus, on one hand, installation space for the lidar system is minimized, while on the other hand, optimal cooling of the lidar system is ensured.

What is claimed is:

1. A sensor unit for a vehicle, comprising:
a housing having cooling fins;
a cooling attachment mounted on the cooling fins;
a fluid inlet;
a fluid outlet;
wherein a fluid is flowable along the cooling fins, and wherein a placement of the cooling fins and the cooling attachment between the fluid inlet and the fluid outlet allows a predefined temperature gradient to be adjusted on the housing.

2. The sensor unit of claim 1, wherein the cooling fins are disposed in a meander-shaped manner, the fluid inlet and the fluid outlet being placed at respective ends of the meander shape.

3. The sensor unit of claim 1, wherein the cooling fins are disposed in a star-shaped manner, the fluid inlet being located at a center point of the star shape and the fluid outlet being located at outer areas of the star shape.

4. The sensor unit of claim 1, wherein the cooling fins are disposed on an outer side of the housing.

5. The sensor unit of claim 1, wherein the housing at least in some areas encloses a sensor, particularly a LIDAR sensor unit.

6. The sensor unit of claim 1, wherein the housing and the cooling attachment are joined permanently and/or in a fluid-tight manner.

7. The sensor unit of claim 1, wherein the fluid includes at least one of air; water; and/or a cooling medium.

8. The sensor unit of claim 1, wherein the cooling attachment extends along an extension direction of the cooling fins, projecting beyond the cooling fins by a projection height that has a maximum of 50% of a cooling-fin height of the cooling fins.

9. A system, comprising:
a sensor unit for a vehicle, including:
a housing having cooling fins;
a cooling attachment mounted on the cooling fins;
a fluid inlet;
a fluid outlet;
wherein a fluid is flowable along the cooling fins, and wherein a placement of the cooling fins and the cooling attachment between the fluid inlet and the fluid outlet allows a predefined temperature gradient to be adjusted on the housing; and
a temperature-adjusting unit coupled to the fluid inlet and fluid outlet, wherein the temperature-adjusting unit is connected via a control line to the sensor unit, either to feed a fluid to the fluid inlet or to stop a fluid feed to the fluid inlet.

10. The system of claim 9, wherein the temperature-adjusting unit is configured to feed cooled and/or heated fluid to the fluid inlet in order to adjust a temperature, specified through the control line, on the housing.

11. The sensor unit of claim 1, wherein the cooling attachment extends along an extension direction of the cooling fins, projecting beyond the cooling fins by a projection height that has a maximum of 30% of a cooling-fin height of the cooling fins.
